(19) United States
(12) Patent Application Publication
(10) Pub. No.: US 2017/0162034 A1
(43) Pub. Date: Jun. 8, 2017

(54) Signaling device and system to mitigate fratricide

(71) Applicants: Mark A. Murawski, Washington, DC (US); Joseph F. Wilson, Newport, NC (US)

(72) Inventors: Mark A. Murawski, Washington, DC (US); Joseph F. Wilson, Newport, NC (US)

(21) Appl. No.: 15/234,016

(22) Filed: Aug. 11, 2016

Related U.S. Application Data
(60) Provisional application No. 62/204,095, filed on Aug. 12, 2015.

(51) Int. Cl. G08B 27/00; G08B 25/01; G08B 21/02

(52) U.S. Cl. CPC G08B 27/001; G08B 21/0269; G08B 25/016

(57) ABSTRACT

An apparatus and system for signaling the presence of a friendly within vicinity of a critical incident. A band adapted to be worn by a user is adapted to provide a visual signal and a communications signal. The band includes a strap having an outer surface and two ends and a pocket defined within the strap. A plurality of light emitting diodes are disposed along the band. An activation unit is housed within a unit housing. The activation unit communicates with the LEDs and also wirelessly with the smartphone of the user. As such, the user's signal is visible and communicates with a friendly, emergency response, and any pre-programmed contact, while also providing a GPS location.

### CROSS-REFERENCE TO RELATED APPLICATIONS

The instant application claims benefit of provisional application Ser. No. 62/204,095 filed Aug. 12, 2015, the contents of which are incorporated herein by reference. BACKGROUND

### FIELD OF THE INVENTION

The present invention relates generally to signaling systems and methods, primarily for the mitigation of fratricide stemming from emergency situations such as active shooter response.

### DESCRIPTION OF THE RELATED ART

Fratricide is the employment of friendly weapons and munitions with the intent to kill the enemy or destroy his equipment or facilities, which results in unforeseen and unintentional death or injury to friendly personnel. Fratricide occurring between law enforcement personnel is unofficially referred to as “Blue on Blue” attacks. Numerous statistics and reports acknowledge that that scenes involving active shooters have become too familiar. Radio transmissions of possible shots fired send the closest police officers to the scene. In today's world, such calls carry with them the memories of school, business, and theater shootings.

The FBI states that responding officers must recognize that in more than half of mass-shooting incidents where a solo officer arrived on the scene—57 percent—shooting still will be underway, with 75 percent requiring law enforcement personnel to confront the perpetrator before the threat ends. One-third of those officers will be shot as they engage. Additionally, first responders face the threat of force as part of their daily jobs. Although tactical teams, such as SWAT, train for barricade situations and multiple-member entries, active-shooter training focuses on five-person-or-less building entries. Responding officers may not previously have trained to face this unique type of threat.

Additional problems identified are that first responders are thinking, “find the shooter and take him out”. Studies show that adrenaline frequently limits senses like hearing and tends to create tunnel vision in officers. As such, officers tend to focus on the weapon alone. Information to responders is limited and can be at times contradicted by information received from victims fleeing the scene. Reduced senses and an incomplete information picture can have dire consequences when there is a multi-agency response to an emergency situation. In some instances, undercover and plain clothed police officers, as well as armed federal agents who do not wear uniforms, may be already on the scene.

While police agencies and individual officers often possess mobile cellular devices and agency-issued radios, there are very few devices designed specifically to act in the same manner as the military's Identification Friend or Foe (IFF) devices that are used on their aircraft. Prior attempts to create a visual signaling device designed to alert others to the presence of non-uniformed, armed LEOs (law enforcement officers) have been primarily limited to articles of clothing identifying the wearer as “POLICE”, “SHERIFF”, or “FEDERAL AGENT”.

U.S. Pat. No. 8,390,463 shows a bracelet including a housing attached to a strap, and a light activated by control electronics. Although the signaling bracelet is not used for friendly fire incidents, it is used for location detection (predominantly fires).

U.S. Pat. No. 8,387,294 teaches flashing LED in response to an alert that law enforcement officer's (LEO's) have drawn their weapons “to help prevent LEO's from shooting each other”. The indicator is on the weapon.

U.S. Publication No. 2014120298, shows a light source transceiver device communicatively coupled to a command and control center and/or mobile device via a network. The command and control center may be a military control center, an emergency response center, including an Enhanced-911 response center.

U.S. Publication No. 20140226645 shows a small, portable wireless router combined with a wideband, wearable antenna supports a local wireless network created on the move for exchanging information between multiple personnel spread over a useful geographic area. Multiple information sources of different types, such as cameras and GPS, can use the network to send information feeds to mobile users with interface devices such as smartphones that can deliver multiple feeds at the same time to the user.

There is a need then for a portable signaling device and system that is designed to alert LEOs to the presence of armed LEO responders using a bracelet or band which communicates first, with the user's own cellphone, then secondly or concurrently with an emergency response center.

### SUMMARY

The invention comprehends a visual and electronic signaling device that provides situational awareness to both uniformed and non-uniformed law enforcement officers (LEO) who are responding to an active shooter or emergency situation which requires immediate and dynamic response by armed LEOs in order to prevent widespread injury or loss of life.

The invention includes a portable visual signaling device, capable of being worn on the body, clothing, or equipment that is designed to alert LEOs to the presence of armed LEO responders; a micro transmitter and global positioning system unit designed to interface with a smart phone; and a smart phone computer application that is designed to relay information from the transmitter to law enforcement/emergency response communication systems.

Once an active shooter or emergency situation requiring an immediate armed response is observed by LEOs who are either in the area or first on scene, the device (hereafter referred to as DSB) is activated. Activation will simultaneously energize the portable visual signaling device that the LEO will be displaying (either on the body, clothing, or equipment) in a prominent place, and will send a signal to the corresponding application that is loaded on the LEO's smart phone/cellular device (hereafter referred to as Smart Phone). The signal from the transmitter will interface with the smart phone application causing an automated phone call to be placed to either a pre-programmed call center, or 911 emergency call centers. Because each device will have a corresponding serial number, the application will identify the device allowing the response call center to determine if multiple devices are present at the scene of the emergency event. Depending on strength of cellular signal, the GPS within the device will provide additional responders with the exact location of the responding officers.

Accordingly, comprehended is an apparatus and system for signaling the presence of a friendly within vicinity of a critical incident, comprising a band adapted to provide a visual signal and a communications signal, the band further comprising a strap having an outer surface and two ends; a pocket defined within the strap near one of the ends; tubing intertwined with the strap between the ends; a plurality of light emitting diodes within the tubing; a plastic cover over the tubing; a means for clasping the ends such that the band can be worn by a user; and, an activation unit within the pocket, the activation unit including a transmitter and a receiver, the transmitter in electronic communication with the light emitting diodes, and the transmitter in wireless communication with a smartphone device of the user.

In the computerized method for signaling the presence of a friendly within vicinity of a critical incident, the steps include: activating a signaling device, wherein the signaling device creates both a visual signal and a communications signal; allowing the communication signal to wirelessly communicate with a smartphone device of the friendly; in response to such wireless communication, automatically contacting a pre-programmed contact; in response to such wireless communication, providing a global positioning system coordinate; and, in response to such wireless communication, enabling nearby, secondary signaling devices.

### BRIEF DESCRIPTION OF THE DRAWINGS

FIG. 1 shows a perspective view of the instant portable, visual signaling device adapted to be worn by a user.

FIG. 2 shows an exploded view in perspective of the visual signaling device.

FIG. 3 shows a side-view in cross-section of the visual signaling device through section 3-3 of FIG. 1.

FIG. 4 shows a diagrammatic illustration the overall system.

FIG. 5 is a flow chart of the basic communications module.

FIG. 6 is a flow chart of the enhanced system with communications module.

FIG. 7 is a flow chart showing the communications module in more detail.

The flow charts and/or sections thereof represent a method with logic or program flow that can be executed by a specialized device and/or implemented on computer readable media or the like (residing on a drive or device after download) tangibly embodying the program of instructions. The executions are typically performed on a computer, but here a specialized device as part of a global communications network such as the Internet. A network may be construed as a local, ethernet connection or a global digital/broadband or wireless network or cloud computing network or the like. The specialized devices defined herein may include any device having circuitry or be a hand-held device, including but not limited to a tablet, smart phone, cellular phone or personal digital assistant (PDA) including but not limited to a mobile smartphone running a mobile software application (App). Accordingly, multiple modes of implementation are possible and “system” as defined herein covers these multiple modes.

### DETAILED DESCRIPTION OF THE PREFERRED EMBODIMENT

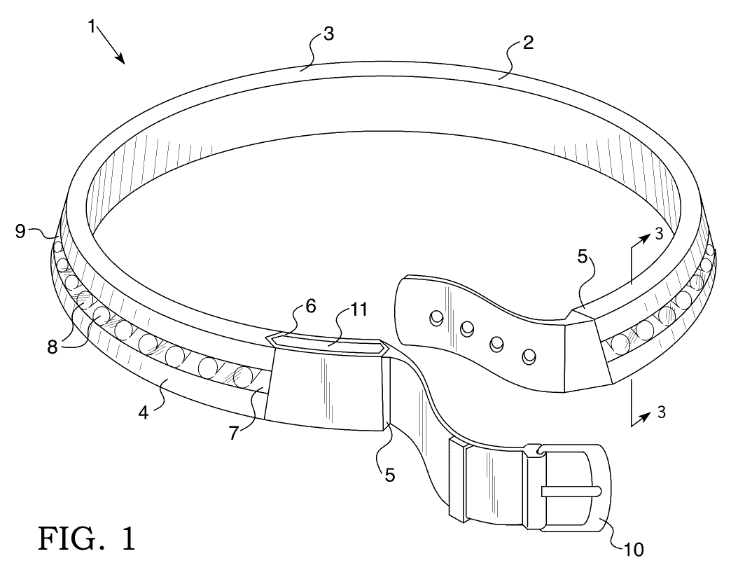

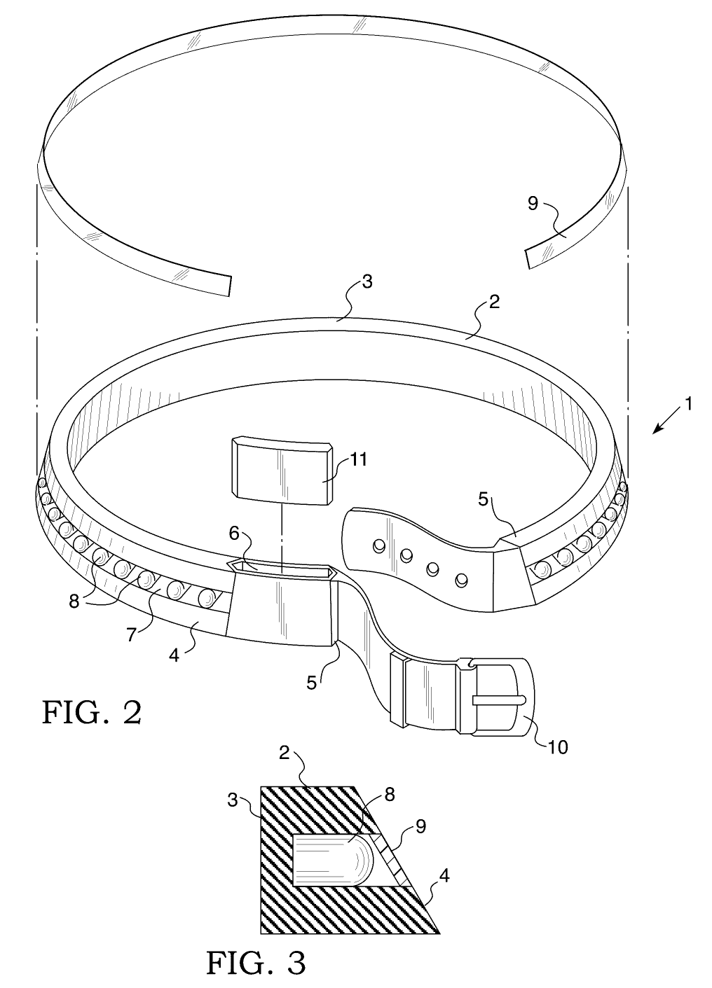

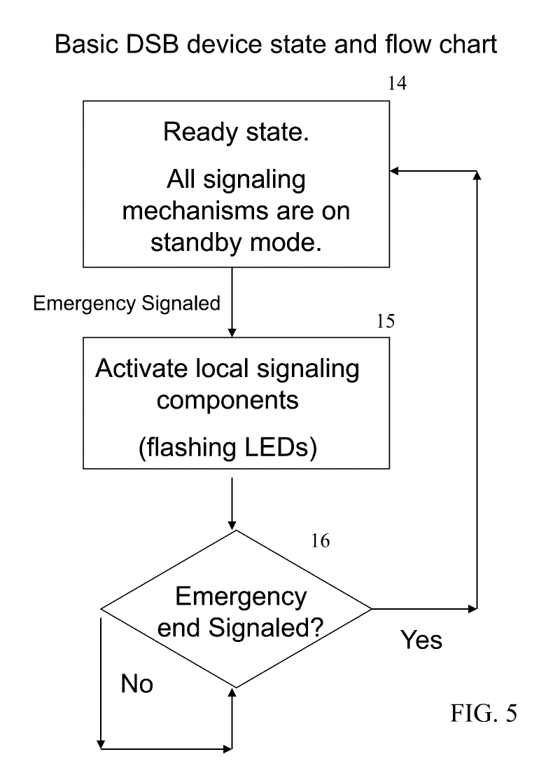

The overall system and methodology comprehends generally two sub-assemblies, namely the mechanical, visual signaling device (FIGS. 1-4), and the smart-phone running application software which interfaces (communicates through its control logic) with the visual signaling device (FIGS. 5-7).

Referencing then FIGS. 1-4, shown is the visual signaling device 1, also termed herein the “don't shoot blue” or DSB device. In the preferred embodiment the DSB 1 takes the form of a band 2 which includes a flexible, bracelet-like strap 3 adapted to be worn about the wrist of the user similar to a watchband, which can be fastened using any type of fastener or clasp means 10. “Worn” in the preferred embodiments means buckled around the wrist of the user but is meant to encompass any type of mechanism to temporarily fasten to a wearer, at any location on the person, e.g. leg or chest by clipping on to clothing, etc. Since the visual signaling device 1 is part of the apparatus for signaling the presence of a friendly within vicinity of a critical incident, “user” here means the person wearing and initially activating the primary DSB 1, and so “friendly” means any nearby responder, law enforcement officer, or non-perpetrating entity who may also be wearing a DSB 1, and thus a “secondary signaling device”. “Communications signal” as used means any wireless technology standard for exchanging data over short distances and in the preferred embodiment is short-link radio technology such as BLUETOOTH.

The visual signaling device 1 with band 2 is adapted to provide a visual signal and a communications signal. A visual signal is a form of light, in the preferred embodiment shown here as a plurality of light-emitting diodes (LED) 8. Accordingly, band 2 includes a strap 3 having an outer surface 4 and two ends 5, shown here capable of being clasped together by clasp 10. A pocket 6 is defined and formed about the strap 3. The pocket 6, or unit housing, can be defined at any location along strap 3, shown here for instance between ends 5 but near the clasp 10. In one embodiment, though not critical, LEDs 8 can be situated within tubing 7 (not easily shown). Tubing 7 can contain the LEDs 8, so tubing 7 is interwined, i.e. embedded by friction or attachment, with the strap 3, traveling between ends 5 within strap 3 as shown. Here, the tubing 7 would be a transparent, flexible material such as plastic, thus the LEDs 8 are within the tubing 7 and visible therethrough. A secondary plastic cover 9 is disposed over the tubing 7 to secure the tubing 7 and thus the LEDs 8 along strap 3. Outer surface 4 can be slightly angled for aesthetic purposes and/or to direct the LED light more outward away from the user to make it more visible to a friendly.

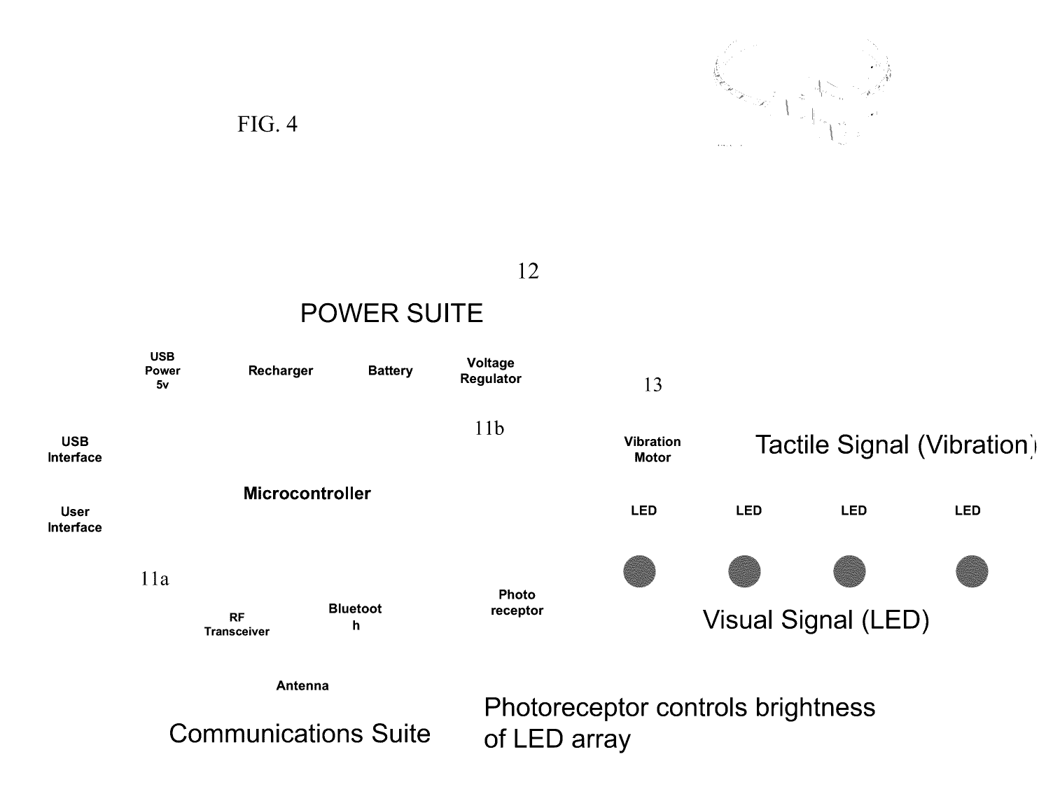

An activation unit 11 combines a communications suite 11a, power source 12 and signal module 13. The signal module 13 includes the visual and tactile or vibration modules. Communication suite 11a includes a microcontroller 11b, which further includes a transmitter and receiver means such as an RF transceiver, Bluetooth, and antenna and is disposed within the pocket 6 (activation unit housing). As above, the activation unit 11 additionally includes a re-chargeable power source 12 (FIG. 4) and optional vibration module 13 (FIG. 4), which is an additional tactile signal. A push-button (not shown) or other activation means is in communication with the activation unit 11, for instance on the side of the activation unit. In a preferred embodiment but not limited thereto, to activate the activation unit 11 the push-button is held down for three (3) seconds. The LEDs 8 (brightness controlled by photoreceptor) are in electronic communication with the transmitter of microcontroller 11b, thus once the transmitter is activated by way of push-button, so too are the LEDs 8, as further described.

Referencing now FIG. 5, the DSB 1 is originally in an un-activated, ready state with all signaling mechanisms in standby mode 14. In a basic variant of the DSB 1, the signaling device 1 is activated, thereby triggering the LEDs 8 and creating a visual signal 15. Although DSB 1 activation with limited to no communication capability is possible, i.e. it is possible that the signaling device 1 could only provide a visual signal 15, in the preferred embodiment the signaling device 1, once activated, also provides a communications signal, and in the basic variant the communications signal is automatic contact to emergency response (911) 16. In this manner, once activated, the DSB 1 communicated with emergency response (911) automatically, meaning simply by its activation is emergency response signaled, in the absence of requiring voice or hand-dialing.

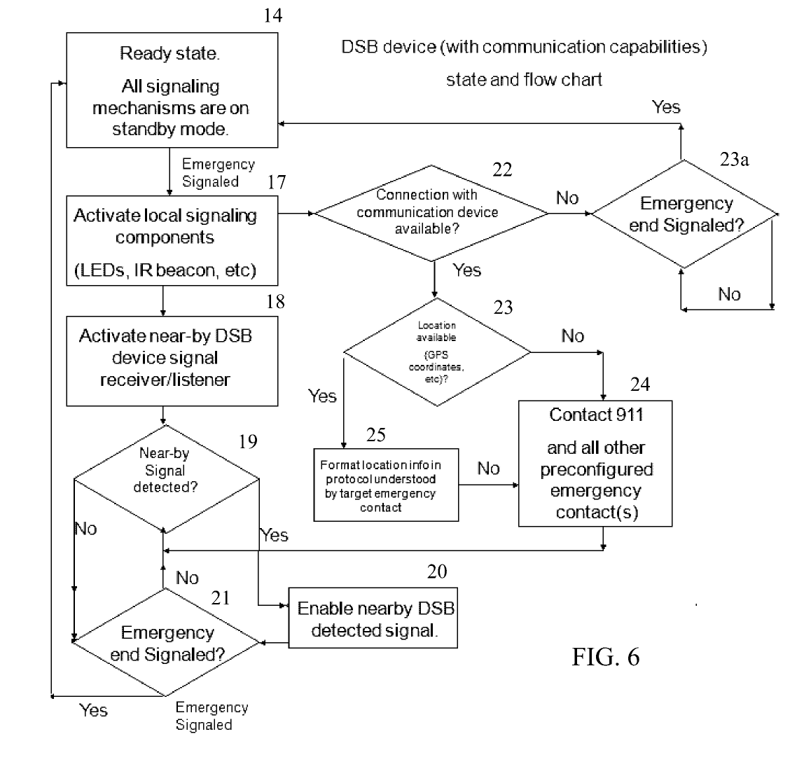

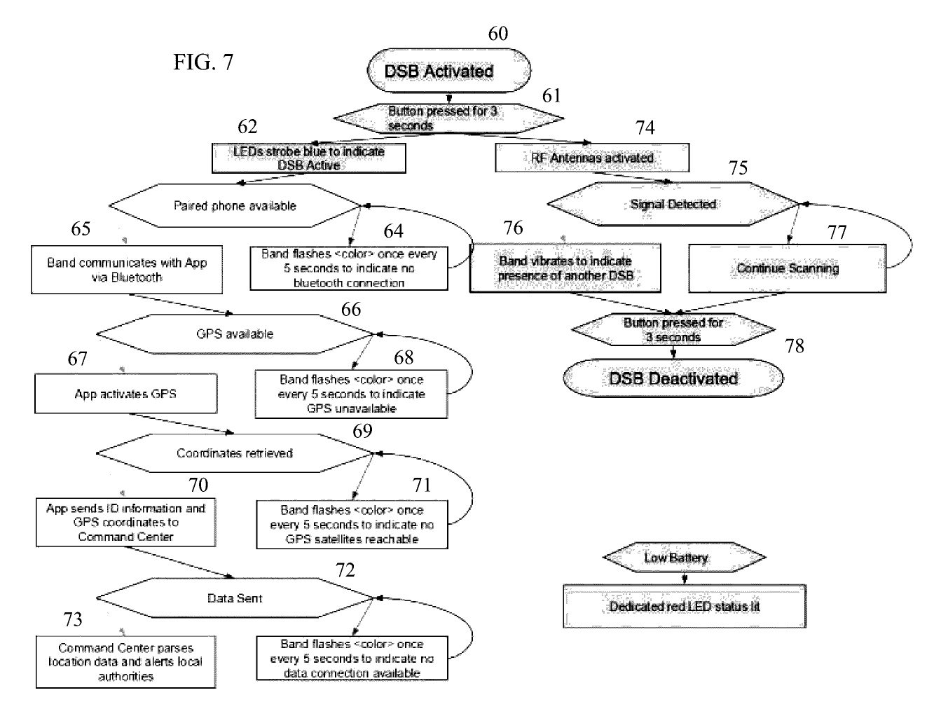

Referencing now FIGS. 6-7, with its communications capability, the local signaling components include more than just the LEDs but additional wireless communications. For instance, as part of the local signaling components 17, the communication signal wirelessly communicates with nearby, secondary signaling devices 18 through infrared or other short-ranged wireless communication packets. Secondary signaling devices means other visual signaling devices worn by alternative users other than the activating user, which receive the transmitted communications signal. As a result, if a nearby signal is detected 19, nearby DSB devices are enabled 20, which, in turn, can provide the same visual signal and communication signals 21. Connection with a secondary device may not be available 22 and out-of-range, in which case no emergency signal would be generated 23. If capable, a smartphone including its mobile application software, receives a signal from the DSB upon transmission 23. Thus, the communication signal is allowed to wirelessly communicate with a smartphone device of the friendly. In response, the Application for DSB V1 will receive the signal from the portable signaling device, and will use the smart-phone transmitter to automatically contact a pre-programmed contact 24 for the purpose of alerting them to the presence of a non-uniformed LEO in the area of a critical event. “Automatically” means the connection is made essentially hands-free and voice-free (no dialing or voice needed for activation). The pre-programmed contact can be a central command center, local emergency response center, or any contact programmed within a contact list on the smartphone. The application will also use the internal GPS to provide an exact location of the LEO 25. The application may also cause the smart-phone to vibrate when it detects the presence of another DSB V1 portable signaling device.

More particularly, in use as it relates to the both the system and the method, the DSB is activated 60. DSB can be activated by depressing any type of actuating mechanism, e.g. a push button pressed for a period of time such as three (3) seconds so as to limit inadvertent actuation 61. As a result, communicating LEDs are activated 62 and the RF antennas are activated. If a paired smartphone is available 63, Bluetooth connection is enabled 64 and through control logic the DSB communicates with a mobile software application 65 (App.). If GPS is available 66, the App. activates the GPS 67. The DSB can have indications that no connections are available 68. If the GPS is activated with coordinates retrieved 69, the App sends identification information and GPS coordinates to a central command center mobile 70 and can implement appropriate indicators 71. As such, the data is sent 72, parsed by the command center, and local authorities can be alerted 73.

With the RF antennas activated 74, a detected signal 75 can pick up secondary DSB devices, indicated for example by the vibrating, primary DSB 76. Continually scanning can take place 77 and each DSB can be deactivated as needed 78.

In use, once activated by the wearer, the LEDs will blink, creating a visual signal that will allow other LEOs to identify responders wearing a DSB V1 as an LEO. The DSB is configured to communicate with the smartphone via blue tooth, thus the DSB V1 will also send a signal to the smart-phone via the blue tooth means. The DSB V1 application in communication with the DSB will simultaneously call the 911 call center (or pre-designated call service center) in order to alert authorities to the presence of non-uniformed LEOs within the immediate vicinity of the critical incident. Depending on the smart phone that is used in conjunction with the signaling device, the system will be able to provide a general grid coordinate of the DSB V1 wearer (using smart-phone GPS). In addition, the application and smart-phone will detect the presence of other DSB V1 devices within the immediate vicinity of the original wearer.

I claim:

1. An apparatus for signaling presence of a friendly within vicinity of a critical incident, comprising:
a band adapted to provide a visual signal and a communications signal, said band further comprising:
a strap having an outer surface and two ends;
a pocket defined within said strap near one of said ends;
tubing intertwined with said strap between said ends;
a plurality of light emitting diodes within said tubing;
a plastic cover over said tubing;
a means for clasping said ends such that said band can be worn by a user; and, an activation unit within said pocket, said activation unit including a communications suite and a signal module, said signal module in electronic communication with said light emitting diodes, and said communications suite in wireless communication with a smartphone device of said user, wherein in response to such wireless communication, a pre-programmed contact is made, a secondary signaling device is activated, and a global positioning system coordinate is provided.

2. The apparatus of claim 1, further including a power source within said activation unit.

3. The apparatus of claim 1, wherein said signal module includes a vibration module.

4. The apparatus of claim 1, wherein said communications suite includes a transmitter and a receiver.

5. The apparatus of claim 1, wherein said communications suite includes a microprocessor.

6. The apparatus of claims 1, wherein said communications suite includes RF components. The apparatus of claim 1, wherein said outer surface is angled.

8. A computer program product comprising a non-transitory computer-readable medium having control logic stored therein for causing a specialized device to signal presence of a friendly within vicinity of a critical incident, the control logic comprising computer-readable program code for causing the specialized device to:
activate a signaling device, wherein said signaling device creates both a visual signal and a communications signal;
allow said communication signal to wirelessly communicate with a smartphone device of said friendly;
in response to such wireless communication, automatically contact a pre-programmed contact;
in response to such wireless communication, provide a global positioning system coordinate; and,
in response to such wireless communication, enable nearby, secondary signaling devices.

9. The computer program product of claim 8, wherein said pre-programmed contact is emergency response.

10. The computer program product of claim 8, wherein said pre-programmed contact is within a contact list on said smartphone device.

11. A system for signaling presence of a friendly within vicinity of a critical incident, comprising:
a signaling device adapted to be worn by a user, wherein said signaling device creates both a visual signal and a communications signal; and,
a smartphone device in wireless communication with said signaling device to receive said communications signal, wherein in response to said communications signal a pre-programmed contact is automatically contacted, and wherein in response to said communications signal a global positioning system coordinate is produced and signaled to said pre-programmed contact, and wherein in response to said communications signal, nearby, secondary signaling devices are enabled.
